(19) United States
(12) Patent Application Publication
(10) Pub. No.: US 2017/0198220 A1
(43) Pub. Date: Jul. 13, 2017

(54) ALIGNMENT FILM AND METHOD FOR MANUFACTURING THE SAME, DISPLAY PANEL AND DISPLAY DEVICE

(71) Applicants: BOE TECHNOLOGY GROUP CO., LTD., Beijing (CN); HEFEI XINSHENG OPTOELECTRONICS TECHNOLOGY CO., LTD., Hefei (CN)

(72) Inventors: Bo ZHANG, Beijing (CN); Cong TAN, Beijing (CN); Fangfang LI, Beijing (CN); Chengyong ZHAN, Beijing (CN)

(21) Appl. No.: 15/241,384

(22) Filed: Aug. 19, 2016

(30) Foreign Application Priority Data
Jan. 13, 2016 (CN) 201610021255.5

(51) Int. Cl. C09K 19/56; G02F 1/1337; C08G 73/10

(52) U.S. Cl. CPC C09K 19/56; C08G 73/10; G02F 1/133723; G02F 2001/133397

(57) ABSTRACT

The present invention provides an alignment film and a method for manufacturing the same, and a display panel and a display device having the alignment film, which belongs to the technical field of displaying. The present invention can solve the problem of image sticking occurring during displaying of the current display panels. The alignment film of the present invention comprises functional material generated by an alcoholysis reaction between polyimide and a capture monomer, wherein the functional material is used to generate a free radical capable of capturing ionic impurities.

### FIELD OF THE INVENTION

The present invention belongs to the technical field of displaying, and particularly relates to an alignment film and a method for manufacturing the same, and a display panel having the alignment film and a display device having the display panel.

### BACKGROUND OF THE INVENTION

In recent years, liquid crystal displays are dominant in the display market, and more and more requirements from users on the display performance and quality thereof have been raised. However, image sticking has always been a significant deficiency to be urgently overcome in the TFT-LCD (Thin Film Transistor Liquid Crystal Display) industry. Since image sticking has severe influence on the image quality of a display, great efforts and resources have been invested in the industry to solve this problem. An important cause for image sticking is that, when the alignment film material, the liquid crystal material and the color filter will release ionic impurities during the displaying by the display panel. These ionic impurities are accumulated in the display region, thus lead to image sticking.

Currently, there are mainly two methods to solve the problem of image sticking in the TFT-LCD industry. The first method is making changes to the design, while the second method is making changes to the manufacturing process.

Though the two methods are useful for solving the problem of image sticking, at least the following problems still exist. On one hand, making changes to the design is to make modifications to the previous design. There is no difference in doing so from developing a novel product; besides, there is no definite certainty that the problem of image sticking will be improved. Thus, making changes to the design will lead to both a longer period and a higher cost for developing a product. On the other hand, making changes to the manufacturing process generally means making changes to the source and drain electrodes and/or the metal layer, the thickness of the alignment film, and the thickness of the protection layer, so as to delay a time of releasing ionic impurities which is only useful for delaying a time of image sticking occurring and cannot actually eliminate the image sticking. Thus, the two methods cannot eliminate image sticking fundamentally.

### SUMMARY OF THE INVENTION

With regard to the problem that image sticking occurring when the current display panels displaying cannot be eliminated, the present invention provides an alignment film capable of effectively eliminating image sticking and a method for manufacturing the same, and a display panel and a display device having the alignment film.

To solve the technical problem, the present invention employs the following technical solution which provides an alignment film comprising a functional material generated by an alcoholysis reaction between polyimide and a capture monomer, wherein the functional material is used to generate a free radical capable of capturing ionic impurities.

Preferably, the functional material is ester compounds having a piperidine structure.

Preferably, the capture monomer has a structural formula of

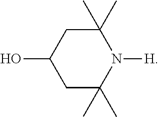

Preferably, the functional material has a structural formula of

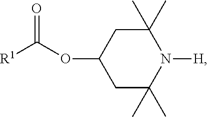

where

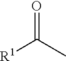

derives from the polyimide.

Preferably, the free radical has a structural formula of

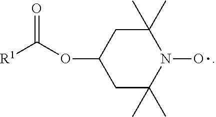

Preferably, the alignment film further includes polyimide, the mass of which is greater than that of the functional material.

Preferably, a mass ratio between the polyimide and the functional material is 20:1 to 5:1.

As another technical solution, the present invention also provides a method for manufacturing an alignment film, including:

generating a functional material by an alcoholysis reaction between polyimide and a capture monomer; and

forming the alignment film from the polyimide and the functional material.

Preferably, the alignment film is formed from the polyimide and the functional material at a temperature between 80□ and 160□.

As another technical solution, the present invention further provides a display panel, including the above alignment film which is used to capture ionic impurities during the display panel displaying and separate from the ionic impurities when the displaying closes.

As another technical solution, the present invention further provides a display device, including the above display panel.

In the alignment film and the method for manufacturing the same, the display panel, and the display device according to the present invention, Since the alignment film includes a functional material generated by an alcoholysis reaction between polyimide and a capture monomer which is used to generate a free radical capable of capturing ionic impurities during the display panel displaying, fewer ionic impurities are accumulated inside the display panel, and further image sticking occurring during the display panel displaying is effectively eliminated so as to fundamentally solve the problem of image sticking. The free radical can also have a reversible reaction when the displaying closes and it will separate from the ionic impurities to become a free radical again. The captured ionic impurities, after separating from the functional free radical, generate ketones or alcohols which will no longer affect the displaying effect. That is to say, the free radical can be used circularly, thus the efficiency for capturing ionic impurities is improved.

### BRIEF DESCRIPTION OF THE DRAWINGS

FIG. 1 is a reaction formula of generating a functional material according to embodiments of the present invention;

FIG. 2 is a reaction formula of generating a free radical according to embodiments of the present invention;

FIG. 3 is a schematic flowchart of a method for manufacturing an alignment film according to embodiments of the present invention; and

FIG. 4 is a schematic view of a reversible reaction between an alignment film and ionic impurities according to embodiments of the present invention.

### DETAILED DESCRIPTION OF THE EMBODIMENTS

In order to make those skilled in the art better understand technical solutions of the present invention, the present invention will be further described in detail with reference to the accompanying drawings and specific embodiments below.

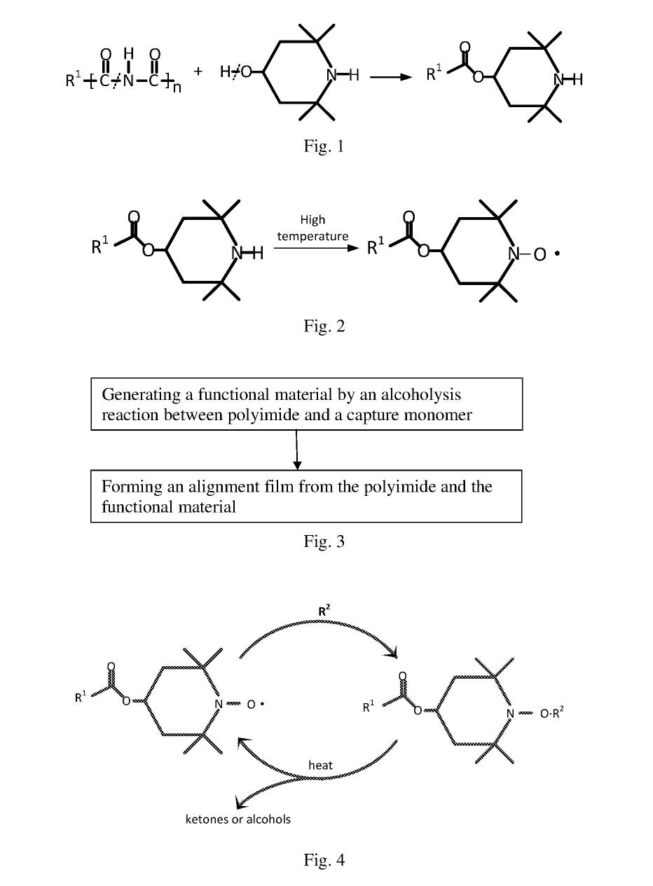

With reference to FIG. 1 and FIG. 2, this embodiment provides an alignment film including a functional material generated by an alcoholysis reaction between polyimide and a capture monomer, wherein the functional material is used to generate a free radical capable of capturing ionic impurities.

The term “a capture monomer” refers to any compound which could perform an alcoholysis reaction with polyimide and generate a functional material which can be used to generate a free radical capable of capturing ionic impurities.

The polyimide has a structural formula of R¹—(CO—NH—CO-)n, wherein R¹ is a substituted or unsubstituted alkyl, cycloalkyl, or heterocyclic group having no carbon-carbon double bond.

Preferably, the capture monomer has a structural formula of

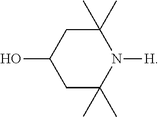

Preferably, the functional material has a structural formula of

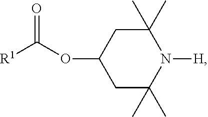

where

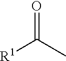

derives from the polyimide.

FIG. 1 shows a reaction formula of generating a functional material by an alcoholysis reaction between polyimide and a capture monomer. During the reaction, a C—N bond of an amide bond

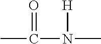

in polyimide breaks (a chemical bond broken with dotted lines in the structure of the polyimide in FIG. 1); an O—H bond of alcohol hydroxyl in the capture monomer

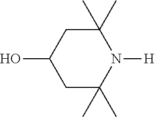

breaks (a chemical bond broken with dotted lines in the structure of the capture monomer in FIG. 1); and then the

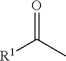

of the polyimide is bonded with

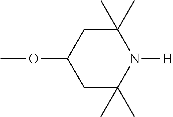

in the capture monomer to form the functional material

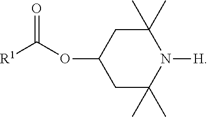

The capture monomer in this embodiment is an alcohol compounds having a piperidine structure. The piperidine structure of the capture monomer is still remained in the functional material generated by its reaction with polyimide, and the capture monomer further forms an ester bond with the polyimide. In this way, the functional material is an ester compound having a piperidine structure.

Of course, the capture monomer in the present invention is not limited thereto and it can also be

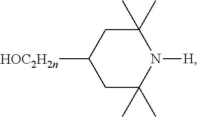

where n is any integer from 2 to 7 as long as the capture monomer is an alcohol compound having a piperidine structure, which can generate ester compounds having a piperidine structure with polyimide, i.e., the functional structure. This will not be repeated here.

Preferably, the free radical has a structural formula of

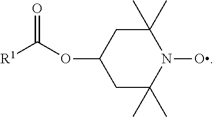

As shown in FIG. 2, the functional material is baked at a high temperature. Since an N—H covalent bond in the alcohol compounds having a piperidine structure will perform homolytic breaking at a high temperature to generate a free radical, therefore the functional material

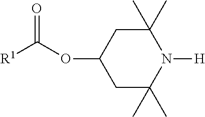

in a high temperature environment can generate a free radical

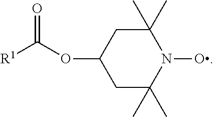

The alignment film of this embodiment further includes polyimide, and the mass thereof is greater than that of the functional material. In this way, the alignment film is mainly made of the polyimide, as long as the functional material exists and is capable of capturing the ionic impurities occurring during displaying. Of course, the mass of the functional material should not be too less, otherwise the alignment film material cannot capture all the ionic impurities occurring during displaying, and thereby not eliminating the image sticking.

Preferably, a mass ratio between the polyimide and the functional material is 20:1 to 5:1.

Ionic impurities include all impurities affecting display effect which is introduced by an alignment film material, a liquid crystal material and a color filter.

Specifically, ionic impurities are impurities affecting display effect which introduced by the various resins used in an alignment film material, a liquid crystal material and a color filter, for example, groups such as —C₃H₇, —CH₂ and —F and the like groups generated by decomposition of the liquid crystal, and ions such as Na⁺, Cl⁻, etc. generated by protection layers, black matrixes and RGB pixels in a color filter.

With reference to FIG. 4, R² denotes ionic impurities, when the free radical in the alignment film “encounters” ionic impurities during the display panel displaying, the free radical

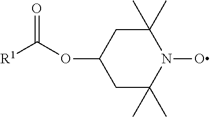

will capture them to form

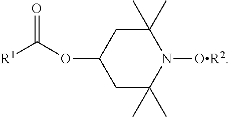

Here, since the free radical captures ionic impurities occurring during displaying, which decrease the accumulation of ionic impurities in the display panel, the amount of accumulated ionic impurities cannot reach a level which could influence liquid crystal deflection. In this way, image sticking occurring during displaying can be effectively eliminated, and fundamentally solve the problem of image sticking.

When the displaying of the display panel closes, since heat is generated during the displaying, after displaying the heat heats the free radical captured the ionic impurities, which make the captured ionic impurities separate from the functional free radical and transform into ketones or alcohols after separation. Specifically, if the ionic impurities captured by the free radical are inorganic ions, the inorganic ions separated still exist as they are; and if the ionic impurities captured by the free radical are organic groups, the organic impurities separated are not stable and likely to bond with each other to form new stable compounds. Types of the formed compounds depend on types of the ionic impurities. For example, if the ionic impurities are resin-like matters in frame-sealing glue, it is more likely to generate ketones. The form of the separated ionic impurities depends on specific situations, and will not be repeated here.

That is to say, the reaction between the free radical and ionic impurities is a reversible reaction. The free radical bonds with ionic impurities when the functional free radical “encounters” ionic impurities. After the displaying ends, the heat generated during the displaying enables the captured ionic impurities to separate from the free radical. After separating from the free radical, the ionic impurities transform into ketones or alcohols. The free radical still remains the original state, and thus it could capture the ionic impurities during the next displaying of the display panel.

The alignment film material of this embodiment includes a functional material generated by an alcoholysis reaction between polyimide and a capture monomer, the functional material is used to generate a free radical capable of capturing ionic impurities. The free radical captures ionic impurities during displaying of a display panel, so as to decrease accumulation of the ionic impurities inside the display panel. In this way, image sticking occurring during the displaying by the display panel is effectively eliminated so as to fundamentally solve the problem of image sticking. The free radical can also have a reversible reaction when the displaying closes and it will separate from the ionic impurities to become a free radical again. The captured ionic impurities, after separating from the functional free radical, generate ketones or alcohols which will no longer affect the displaying effect. That is to say, the free radical can be used circularly, thus the efficiency for capturing ionic impurities is improved.

With reference to FIG. 3, another embodiment of the present invention provides a method for manufacturing the above alignment film, including:

Step 101: generating a functional material by an alcoholysis reaction between polyimide and a capture monomer; and

step 102: heating the polyimide and the functional material to form an alignment film, wherein the heat temperature is 80° C. to 160° C. and the heating time is 1000-1800 Second.

Yet another embodiment of the present invention provides a display panel, including the above alignment film which is used to capture ionic impurities during the displaying of the display panel and separate from the ionic impurities at the end of the displaying of the display panel.

Another embodiment of the present invention provides a display device, including the above display panel. The display device can be any products or components with a display function, such as a liquid crystal display panel, electronic paper, a cell phone, a tablet computer, a TV set, a display, a notebook computer, a digital photo frame, and a navigator.

In this embodiment, the display device including the display panel according to the present invention can effectively eliminate image sticking occurring during the displaying so as to fundamentally solve the problem of image sticking.

It can be understood that the foregoing embodiments are merely illustrative embodiments employed for describing the principle of the present invention. However, the present invention is not limited thereto. For a person of ordinary skill in the art, various deformations and improvements can be made without departing from the spirit and essence of the present invention. These deformations and modifications shall fall into the protection scope of the present invention.

1. An alignment film, comprising functional material generated by an alcoholysis reaction between polyimide and a capture monomer, wherein the functional material is used to generate a free radical capable of capturing ionic impurities.

2. The alignment film according to claim 1, characterized in that the functional material is ester compounds having a piperidine structure.

3. The alignment film according to claim 1, characterized in that the capture monomer has a structural formula of

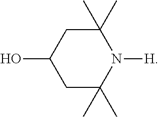

4. The alignment film according to claim 2, characterized in that the functional material has a structural formula of 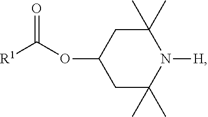
where 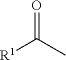
derives from the polyimide.

5. The alignment film according to claim 2, characterized in that the free radical has a structural formula of

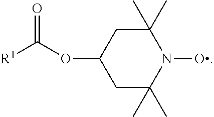

6. The alignment film according to claim 1, characterized in that the alignment film further comprises polyimide, and a mass of the polyimide is greater than that of the functional material.

7. The alignment film according to claim 6, characterized in that a mass ratio between the polyimide and the functional material is 20:1 to 5:1.

8. A method for manufacturing an alignment film, comprising:
generating functional material by an alcoholysis reaction between polyimide and a capture monomer; and
forming an alignment film from the polyimide and the functional material.

9. The method for manufacturing an alignment film according to claim 8, characterized in that a temperature for forming the alignment film from the polyimide and the functional material is 80° C. to 160° C.

10. A display panel, comprising the alignment film according to claim 1, wherein the alignment film is used to capture ionic impurities during the displaying of the display panel and separate from the ionic impurities after the displaying of the display panel.

11. A display device, comprising the display panel according to claim 10.
